(19) United States
(12) Patent Application Publication
(10) Pub. No.: US 2024/0070692 A1
(43) Pub. Date: Feb. 29, 2024

(54) Systems and Methods for Calculating Latency Metrics and Disabling User Experiments

(71) Applicant: COUPANG CORP., Seoul (KR)

(72) Inventors: Xiaowei GONG, Shanghai (CN); Ngoc-Lan Isabelle PHAN, Shanghai (CN); Xianbing LING, Shanghai (CN); Aldi TJAHJADI, Shanghai (CN)

(73) Assignee: COUPANG CORP., Seoul (KR)

(21) Appl. No.: 17/822,979

(22) Filed: Aug. 29, 2022

(51) Int. Cl. H04L 41/5061; H04L 43/0852

(52) U.S. Cl. CPC H04L 41/5064; H04L 43/0852

(57) ABSTRACT

The embodiments of the present disclosure provide systems and methods for optimizing calculations of latency metrics for user experiments, comprising receiving from a user device over a network, experiment parameters related to a first experiment of a set of experiments, the set of experiments comprising at least one of a treatment group and at least one of a control group. The experiment parameters are associated with at least one webpage. The user device receives over a network time till interaction (TTI) data for the first experiment, wherein the TTI data comprises a time value and a unique identifier. TTI is calculated for each treatment group experiment and for each control group experiment. If the treatment group experiment value is greater than the predetermined threshold value, the systems and methods send a notification informing users or disable activation of the treatment group experiment.

### TECHNICAL FIELD

The present disclosure generally relates to computerized systems and methods for calculating latency metrics in user experiments and minimizing lag times. In particular, embodiments of the present disclosure relate to inventive and unconventional systems related to calculating latency metrics in user experiments and minimizing lag times between network devices and running experiments.

### BACKGROUND

A/B testing is an important tool that prevents developers from spending time and resources creating and developing website features that customers do not utilize. Order fulfillment companies may use A/B testing on their webpages to better understand how customers respond to changes of specific elements on a webpage. A/B testing may include preparing two versions of a webpage with variations in the forms and visualizations of elements of the webpage, which may be utilized to measure the effects in factors such as variations of sales. Understanding how customers interact with features of a webpage can maximize profits by attracting customers using webpages features that customers have positively responded to using A/B testing.

While A/B testing is a useful tool, such testing can take many resources and time. A/B testing can lead to a slower customer experience if a page takes too long to load. A page may take longer to load because two versions of content are shown to customers at different times. This may create a poor customer experience that could prevent customers from visiting the webpage again or cause them to leave the webpage, which may lead to a decrease in sales. The amount of time it takes for a webpage to load is an important metric, known as the lag time. Therefore, the reduction of latency is critical to improving the customer experience.

However, measuring lag time with hundreds of different A/B tests running is difficult. For organizations running many A/B tests, measuring the lag time of tests may introduce errors and inconsistencies. Additionally, organizations may need to scale certain webpage versions quickly or deactivate certain webpage versions quickly to minimize lag times and not disrupt the user experience. Notifying developers immediately when there is a disruption or unexpected increase in the time it takes a webpage to load or render is important because long load/render times can consume unnecessary resources, lead to decreased delivery of information, and detract from the overall experience. It may not always be clear to developers when there is a webpage lag time. Sending an immediate notification allows for developers and back-end users to take immediate action to rectify potential issues. Therefore, there is a need for an alert system to avoid delays, streamline processes, and increase efficiency.

Therefore, there is a need for improved methods and systems for calculating latency metrics in user experiments and minimizing lag times.

### SUMMARY

One aspect of the present disclosure is directed to a computerized system for calculating latency metrics for user experiments. The computerized system may comprise a memory storing instructions and at least one or more processors. The at least one or more processors may be configured to perform steps comprising: receiving, from a user device over a network, experiment parameters related to a first experiment of a set of experiments, the set of experiments comprising at least one of a treatment group experiment and at least one of a control group experiment, the parameters associated with at least one webpage; receiving, from a user device over a network, time till interaction (TTI) data for the first experiment, wherein the TTI data comprises a time value and a unique identifier; calculating a value of TTI for each treatment group experiment; calculating a value of TTI for each control group experiment; comparing the value of TTI from the treatment group experiment with the value of TTI from the control group experiment; determining whether the difference between the value of TTI from the treatment group experiment and the value of TTI from the control group experiment is greater than a predetermined threshold value; maintaining the treatment group experiment and the control group experiment until the value is greater than the predetermined threshold; and sending a notification indicating that the treatment group experiment value is greater than the predetermined threshold value.

Another aspect of the present disclosure is directed to a method for calculating latency metrics for user experiments, comprising: receiving, from a user device over a network, experiment parameters related to a first experiment of a set of experiments, the set of experiments comprising at least one of a treatment group experiment and at least one of a control group experiment, the parameters associated with at least one webpage; receiving, from a user device over a network, time till interaction (TTI) data for the first experiment, wherein the TTI data comprises a time value and a unique identifier; calculating a value of TTI for each treatment group experiment; calculating a value of TTI for each control group experiment; comparing the value of TTI from the treatment group experiment with the value of TTI from the control group experiment; determining whether the difference between the value of TTI from the treatment group experiment and the value of TTI from the control group experiment is greater than a predetermined threshold value; maintaining the treatment group experiment and the control group experiment until the value is greater than the predetermined threshold; and sending a notification indicating that the treatment group experiment value is greater than the predetermined threshold value.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Detail Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 illustrates a network of devices, which includes a network and system for calculating latency metrics, consistent with disclosed embodiments.

FIG. 4 is a schematic of an exemplary process flow for calculating TTI values and sending a notification if the value of the treatment group experiment is greater than the predetermined threshold value, consistent with disclosed embodiments.

FIG. 5 is a flow chart of an exemplary method of calculating latency metrics for user experiments, consistent with disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured for calculating latency metrics for user experiments.

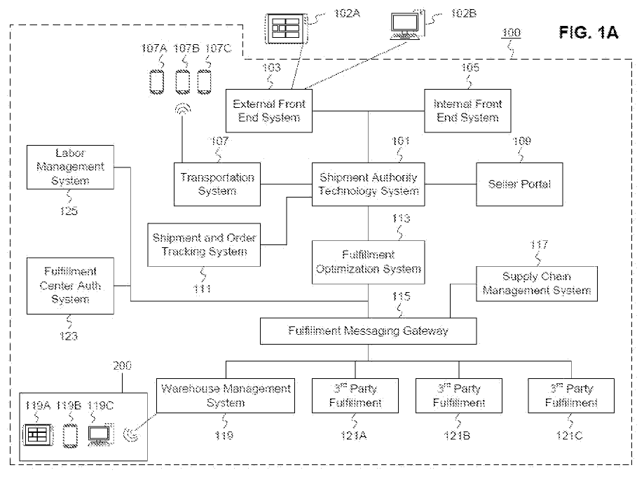

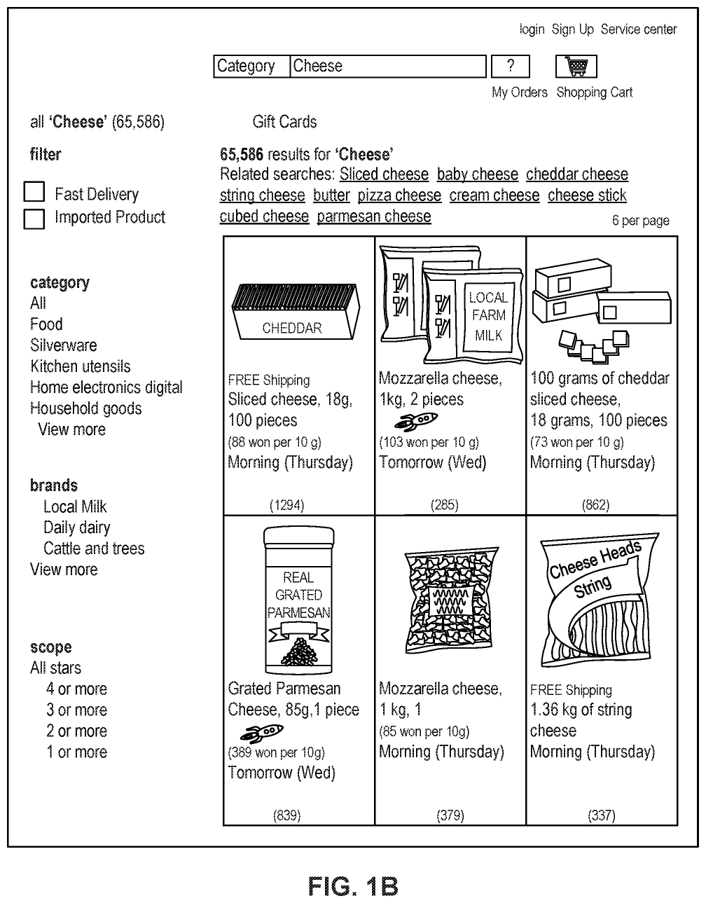

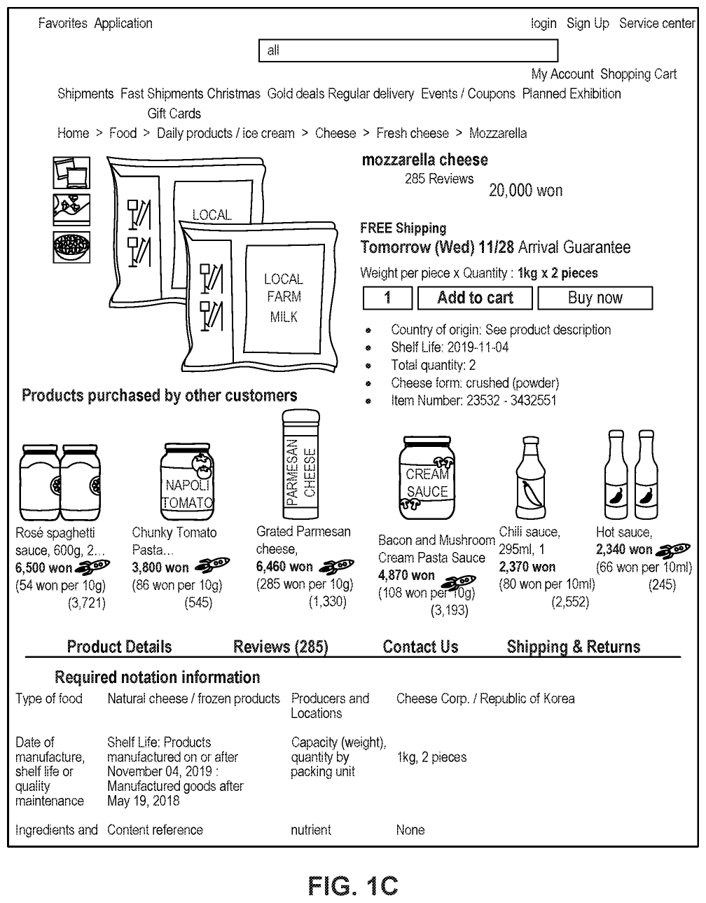

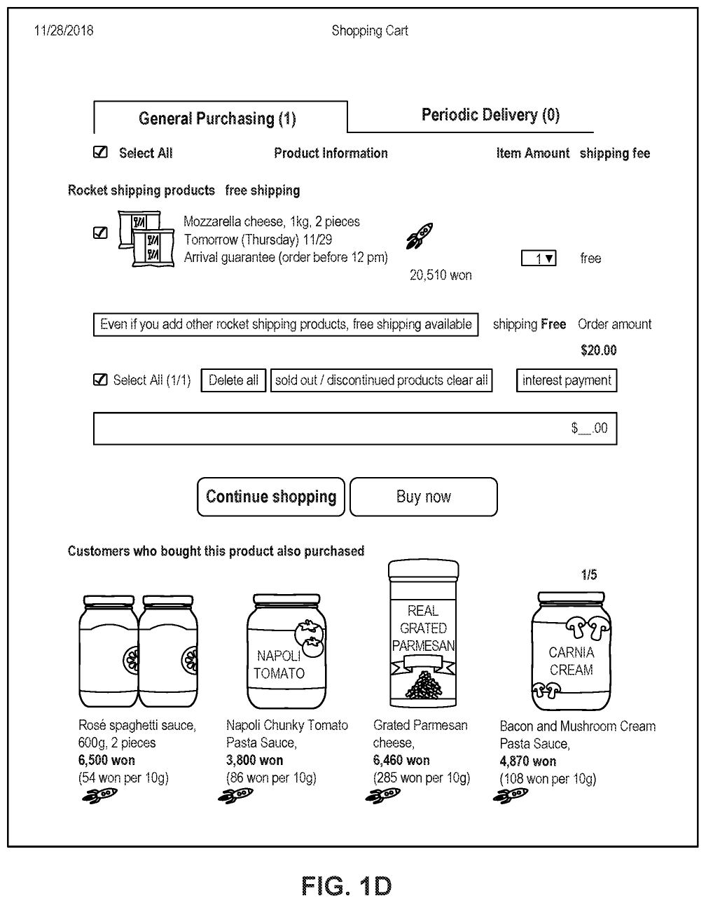

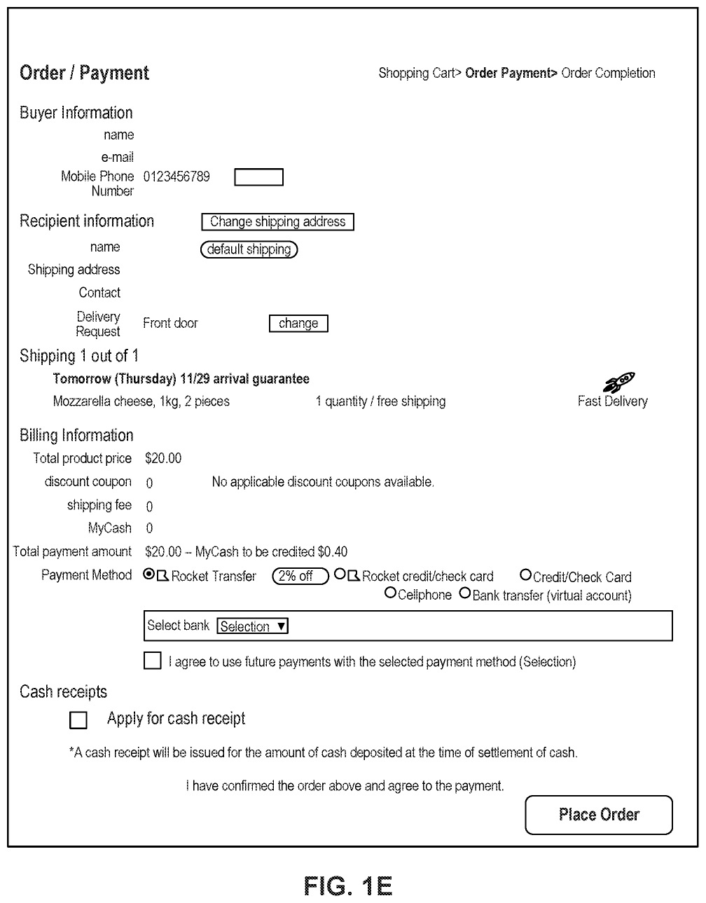

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where system 100 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3^{rd} party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count of products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

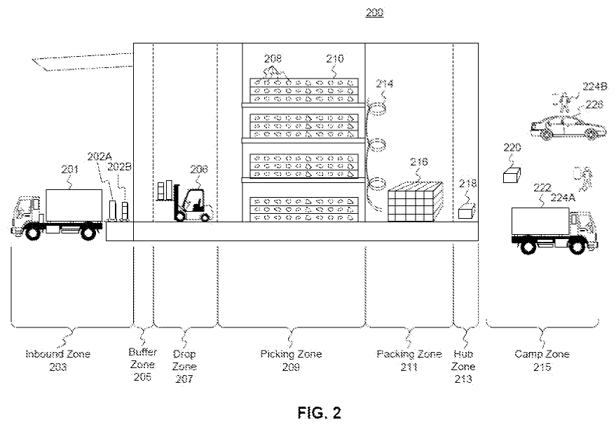

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 119B, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMS 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 119B.

Once a user places an order, a picker may receive an instruction on device 119B to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

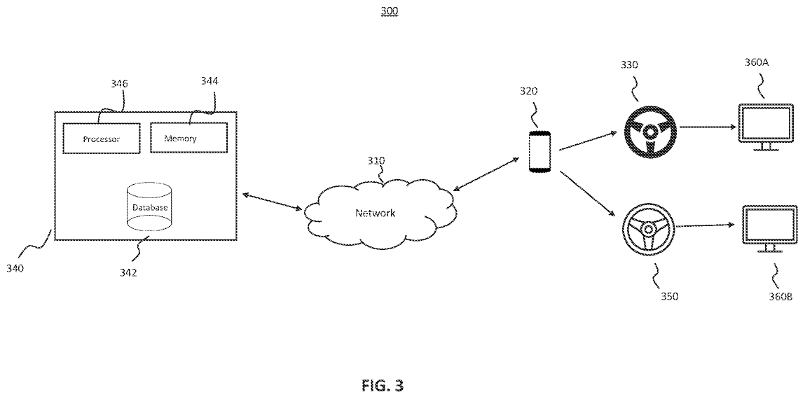

FIG. 3 depicts a network of devices 300, which includes a network 310 and system 340 for calculating latency metrics, consistent with disclosed embodiments. System 340 includes at least one processor 346, a memory storing instructions 344, and database 342. The memory 344 stores a program for calculating latency metrics. The program may be implemented using external front end system 103 as a web server that receives search requests, presents item pages, and solicits payment information using A/B testing. Network 310 may communicate with user device 320 and system 340. User device 320 may receive treatment group experiment parameters 330 and control group experiment parameters 350. Treatment group experiment parameters 330 are associated with at least one webpage 360A. Control group experiment parameters 350 are associated with at least one webpage 360B. An experiment parameter is any characteristic that defines a feature or element of the web page. In some embodiments, a treatment group experiment parameter may be a parameter with a change applied to it. In some embodiments, the control group experiment parameter may be a parameter where no change is applied to it. For example, in some embodiments the control group experiment parameters may show a webpage as illustrated in FIG. 1B. By contrast, the treatment group experiment parameter may show a webpage as illustrated in FIG. 1B that has text enlarged by twice the size, or text that is shown in a color other than black, or does not illustrate pictures of the types of cheese. For example, in some embodiments, the control group experiment parameters may show a webpage as illustrated in FIG. 1C. By contrast, the treatment group experiment parameter may show a webpage as illustrated in FIG. 1C with text that is smaller in size, or text that is shown in a color other than black, or indicates that a user may choose to view products purchased by other customers by clicking a dropdown menu. By using A/B testing, the system 340 may determine whether a user clicks on certain features of the page, or navigates away from the page. The system 340 may also determine whether a user makes changes to a page, for example, to increase or decrease the font size.

System 340 is configured to measure latency metrics and may be associated with one or more systems in system 100 of FIG. 1A via a direct connection. In some embodiments, system 340 processes latency metrics and generates latency metric source tables. In some embodiments, system 340 collects and processes weblog data. In some embodiments, system 340 stores raw data in a data warehouse system such as Apache Hive. In some embodiments, system 340 calculates latency metrics hourly. In some embodiments, system 340 may communicate with the other components of system 100 via network 310 or via a direct connection. System 340 may include one or more processors 346.

Processor 346 may be a generic or specific electronic device capable of manipulating or processing information. For example, the processor may include any combination of any number of a central processing unit (CPU), a graphics processing unit (GPU), an optical processor, a programmable logic controllers, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FGPA), a System on Chip (SoC), an Application-Specific Integrated Circuit (ASIC), and any type of circuit capable of data processing. The processor may also be a virtual processor that includes one or more processors distributed across multiple machines or devices coupled via a network.

Memory 344 may be a generic or specific electronic device capable of storing codes and data accessible by the processor. For example, memory 344 may include any combination of any number of a random-access memory (RAM), a read-only memory (ROM), an optical disc, a magnetic disc, a hard drive, a solid-state drive, a flash drive, a security digital (SD) card, a memory stick, a compact flash (CF) card, or any type of storage device. The codes may include an operating system (OS) and one or more application programs for specific tasks. The memory may also be a virtual memory that includes one or more memories distributed across multiple machines or devices coupled via a network.

Database 342 is connected to system 340. Database 342 may comprise a processor and memory. In some embodiments, system 340 may concurrently operate as database 342.

System 340 is connected to computer network 310. For example, computer network 310 may include any combination of any number of the Internet, an Intranet, a Local-Area Network (LAN), a Wide-Area Network (WAN). a Metropolitan Area Network (MAN), a virtual private network (VPN), a wireless network, a wired network, a leased line, a cellular data network, and a network using Bluetooth connections, infrared connections, or Near-Field Communication (NFC) connections.

System 340 is further connected, either directly or via computer network 310 to user device 320. User device 320 may be a laptop, standalone computer, tablet, mobile phone, and the like. In some embodiments, system 340 and user device 320 may be directly connected such that information exchanged between system 340 and user device 320 does not pass over computer network 310. In some embodiments, user device 320 is connected to Wi-Fi.

System 340 receives treatment group experiment parameters 330 and control group experiment parameters 350 via user device 320. Each treatment group experiment parameter 330 is associated with at least one webpage 360A. Each control group experiment parameter is associated with at least one webpage 360B. Webpages 360A and 360B display the A/B tests.

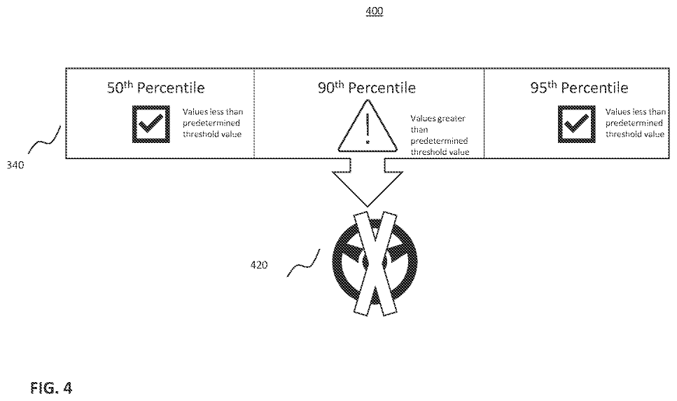

FIG. 4 is a schematic of an exemplary process for calculating TTI values and disabling activation of the treatment group experiment, consistent with disclosed embodiments. TTI may be a web performance progress metric that measures how long it takes for a web page to become fully interactive. In some embodiments, a page is fully interactive when the page responds to user interactions within 500 milliseconds. The TTI values are calculated using a Spark job. System 340 outputs the calculated predetermined threshold values of step 550 based on TTI values for the treatment group experiment and the control group experiment at percentile values of 50%, 90%, and 95%. In some embodiments, the Spark job calculates an average percentile value from the 50%, 90%, and 95% values. In some embodiments, the Spark job is calculated at these percentile values because they capture the majority of a user experience. In some embodiments, the TTI values are calculated for each platform, page, and network. In some embodiments the platform is an operating system. In some embodiments the network operates using WiFi. In some embodiments the network operates using cellular data. In some embodiments, the percentile values are calculated every four hours. If values are greater than the predetermined threshold value, then at notification 420, system 340 sends a notification to a user device. For example, a user device may include a mobile device, laptop, tablet, standalone computer or the like. FIG. 4 illustrates sending a notification at the 90^{th} percentile value. In some embodiments, when notification 420 is sent to a user device, process 400 automatically disables the treatment group experiment.

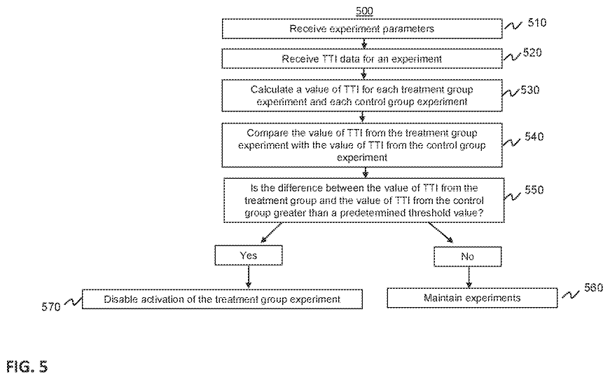

FIG. 5 is a flow chart of an exemplary method of calculating latency metrics for user experiments, consistent with disclosed embodiments. Process 500 begins at step 510. In step 510, system 340 receives experiment parameters via user device 320 over network 310. The experiment parameters are related to a first experiment of a set of experiments. In some embodiments, there may be more than one experiment related to a set of experiments. The set of experiments comprises at least one of a treatment group experiment and at least one of a control group experiment for use in A/B testing. The treatment group experiment parameters 330 are associated with the treatment group experiment. The control group experiment parameters 350 are associated with the control group experiment. Each of the treatment group experiment parameters 330 is associated with a webpage 360A and each of the control group experiment parameters 350 is associated with a webpage 360B. Webpages 360A and 360B display the A/B tests.

Process 500 then proceeds to step 520. In step 520, system 340 receives time till interaction (TTI) data for an experiment. The TTI data comprises a time value and a unique identifier. The time value represents the time that the TTI data was received from user device 320 over network 310. The experiment is at least one of a treatment group experiment and at least one of a control group experiment.

Process 500 then proceeds to step 530. In step 530, system 340 calculates a value of TTI for each treatment group experiment and each control group experiment. The TTI data is calculated by measuring how long it takes for a web page to load for a treatment group experiment and is compared against how long it takes for a web page to load for a control group experiment.

Process 500 then proceeds to step 540. In step 540, system 340 compares the value of TTI from the treatment group experiment with the value of TTI from the control group experiment. Webpages 360A and 360B measure the TTI value each time a user visits a webpage. The TTI value is stored in memory 344. System 340 receives the stored TTI values over network 310. The values of TTI data are stored in memory 344.

Process 500 then proceeds to step 550. If at step 550, it is determined that the difference between the value of TTI from the treatment group and the value of TTI from the control group is greater than a predetermined threshold value, then at step 570, the system sends a notification indicating that the value of TTI from the treatment group is greater than a predetermined threshold value. In such a situation, a web page developer needs better latency for A/B testing. In some embodiments, the process reverts to step 540 where the value of TTI from the treatment group experiment is compared with the value of the control group experiment. In alternative embodiments, at step 570, the system 340 logs each time the treatment group experiment is associated with a notification and places each treatment group associated with a notification in a priority queue based on at least one of a time value and a unique identifier. In some embodiments, system 340 maintains a log for these treatment group experiments for use during review of A/B testing. The priority queue may be used by developers to analyze A/B testing. In some embodiments system 340 accesses the priority queue of treatment groups associated with a notification and determines that the latency value is less than a predetermined threshold value and activates the treatment group experiment based on the priority queue. In alternative embodiments, if at step 550 it is determined that the difference between the value of TTI from the treatment group and the value of TTI from the control group is greater than a predetermined threshold value, then at step 570, the system disables activation of the treatment group experiment. In some embodiments, system 340 logs each time the treatment group experiment is disabled and places each disabled treatment group in a priority queue based on at least one of a time value and a unique identifier. In some embodiments, system 340 maintains a log for disabled treatment group experiments for use during review of A/B testing. The priority queue may be used by developers to analyze A/B testing. In some embodiments, system 340 access the priority queue of disabled treatment groups and determines that the latency is less than a predetermined threshold value and activates the treatment group experiment based on the priority queue.

In some embodiments, the difference between the value of TTI from the treatment group and the value of TTI from the control group is known as the latency value. While in some embodiments, system 340 may generate and send a notification after seven days of value comparison, in other embodiments system 340 may disable activation of the treatment group experiment after seven days of value comparison. The value comparison may require that for seven consecutive days the value of TTI from the treatment group and the value of TTI from the control group was greater than a predetermined threshold value. If at step 570 the treatment group experiment is disabled, the control group experiment remains active.

If, on the other hand, at step 550, it is determined that the difference between the value of TTI from the treatment group and the value of TTI from the control group is not greater than a predetermined threshold value, then at step 560, the treatment group experiment and the control group experiment are maintained with no change and no notification is sent.

The predetermined threshold value of step 550 is calculated based on TTI values for the treatment group and the control group at percentile values of 50%, 90%, and 95% as illustrated in FIG. 4. In some embodiments, the predetermined threshold value may be a value of 3%.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A computerized system for calculating latency metrics for user experiments, comprising:
at least one processor
at least one non-transitory storage medium comprising instructions that, when executed by the at least one processor, cause the at least one processor to perform steps comprising:
receiving, from a user device over a network, experiment parameters related to a first experiment of a set of experiments, the set of experiments comprising at least one of a treatment group experiment and at least one of a control group experiment, the parameters associated with at least one webpage;
receiving, from a user device over a network, time till interaction (TTI) data for the first experiment, wherein the TTI data comprises a time value and a unique identifier;
calculating a value of TTI for each treatment group experiment;
calculating a value of TTI for each control group experiment;
comparing the value of TTI from the treatment group experiment with the value of TTI from the control group experiment;
determining whether the difference between the value of TTI from the treatment group experiment and the value of TTI from the control group experiment is greater than a predetermined threshold value;
maintaining the treatment group experiment and the control group experiment until the value is greater than the predetermined threshold; and
sending a notification indicating that the treatment group experiment value is greater than the predetermined threshold value.

2. The computerized system of claim 1, wherein the predetermined threshold value is calculated based on TTI values for the treatment group and the control group at percentile values of 50%, 90%, and 95%.

3. The computerized system of claim 1, wherein the determining the difference between the value of TTI from the treatment group and the value of TTI from the control group further comprises at least one of:
sending a notification if the treatment group experiment value is greater than the predetermined threshold value after seven days of value comparison or
disabling activation of the treatment group experiment if the value is greater than the predetermined threshold value after seven days of value comparison.

4. The computerized system of claim 1, wherein the operations further comprise allowing a user to use the control group experiment if the system disables activation of the treatment group experiment.

5. The computerized system of claim 1, wherein the user device is connected to Wi-Fi before running the set of experiments.

6. The computerized system of claim 1, wherein the value of TTI for each experiment is based on parameters associated with the webpage.

7. The computerized system of claim 1, wherein the system logs each time a notification is sent indicating that the treatment group experiment value is greater than the predetermined threshold value, based on the time value and the unique identifier.

8. The computerized system of claim 1, wherein the operations further comprise maintaining a log of disabled treatment group experiments.

9. The computerized system of claim 1, wherein each treatment group experiment associated with a notification is placed in a priority queue for further analysis.

10. The computerized system of claim 1, wherein the operations further comprise:
accessing the priority queue of treatment groups associated with a notification;
determining that the difference between the value of TTI from the treatment group experiment and the value of TTI from the control group experiment is less than a predetermined threshold value; and
activating the treatment group experiment.

11. A computer-implemented method for calculating latency metrics for user experiments, the method comprising:
receiving, from a user device over a network, experiment parameters related to a first experiment of a set of experiments, the set of experiments comprising at least one of a treatment group experiment and at least one of a control group experiment, the parameters associated with at least one webpage;
receiving, from a user device over a network, time till interaction (TTI) data for the first experiment, wherein the TTI data comprises a time value and a unique identifier;
calculating a value of TTI for each treatment group experiment;
calculating a value of TTI for each control group experiment;
comparing the value of TTI from the treatment group experiment with the value of TTI from the control group experiment;
determining whether the difference between the value of TTI from the treatment group experiment and the value of TTI from the control group experiment is greater than a predetermined threshold value;
maintaining the treatment group experiment and the control group experiment until the value is greater than the predetermined threshold; and
sending a notification indicating that the treatment group experiment value is greater than the predetermined threshold value.

12. The computer-implemented method of claim 11, wherein the predetermined threshold value is calculated based on TTI values for the treatment group and the control group at percentile values of 50%, 90%, and 95%.

13. The computer-implemented method of claim 11, wherein the determining the difference between the value of TTI from the treatment group and the value of TTI from the control group further comprises at least one of:
sending a notification if the treatment group experiment value is greater than the predetermined threshold value after seven days of value comparison or
disabling activation of the treatment group experiment if the value is greater than the predetermined threshold value after seven days of value comparison.

14. The computer-implemented method of claim 11, wherein the operations further comprise allowing a user to use the control group experiment if the system disables activation of the treatment group experiment.

15. The computer-implemented method of claim 11, wherein the user device is connected to Wi-Fi before running the set of experiments.

16. The computer-implemented method of claim 11, wherein the value of TTI for each experiment is based on parameters associated with the webpage.

17. The computer-implemented method of claim 11, wherein the system logs each time a notification is sent indicating that the treatment group experiment value is greater than the predetermined threshold value, based on the time value and the unique identifier.

18. The computer-implemented system of claim 11, wherein the operations further comprise maintaining a log of disabled treatment group experiments.

19. The computer-implemented method of claim 11, wherein each treatment group experiment associated with a notification is placed in a priority queue for further analysis.

20. The computer-implemented method of claim 11, wherein the operations further comprise:
accessing the priority queue of treatment groups associated with a notification;
determining that the difference between the value of TTI from the treatment group experiment and the value of TTI from the control group experiment is less than a predetermined threshold value; and
activating the treatment group experiment.
